(19) United States
(12) Patent Application Publication
(10) Pub. No.: US 2020/0053110 A1
(43) Pub. Date: Feb. 13, 2020

(54) METHOD OF DETECTING ABNORMAL BEHAVIOR OF USER OF COMPUTER NETWORK SYSTEM

(71) Applicant: Han Si An Xin (Beijing) Software Technology Co., Ltd, Beijing (CN)

(72) Inventors: Xiaochuan WAN, Beijing (CN); Hanzhao GAO, Beijing (CN); Rui WU, Beijing (CN)

(21) Appl. No.: 16/498,910

(22) PCT Filed: Mar. 26, 2018
(86) PCT No.: PCT/CN2018/080488

§ 371 Date: Sep. 27, 2019

(30) Foreign Application Priority Data
Mar. 28, 2017 (CN) 201710189974.2

(51) Int. Cl. H04L 29/06; G06F 11/34; G06K 9/00

(52) U.S. Cl. CPC H04L 63/1425; H04L 63/1416; G06F 11/3476; G06K 9/00335; G06F 11/3452; G06F 11/3409

(57) ABSTRACT

Provided in the present invention is a method of detecting an abnormal behavior of a user of a computer network system, the method comprising: selecting at least two data sources in the computer network system; extracting data of user behaviors respectively from the corresponding data sources using a configured tensor data structure, and aggregating the extracted data; and detecting abnormality of user behaviors on the basis of the aggregated tensor data. The method of the present invention can efficiently integrate a large volume of irrelevant security data and identify an abnormal behavior automatically.

### TECHNICAL FIELD

The present invention relates to the field of information security, and in particular to a method for detecting an abnormal behavior of a user of a computer network system.

### BACKGROUND ART

The current field of information security is facing a variety of challenges: on the one hand, as the enterprise security architecture is increasingly complex and more and more types of security equipment and security data emerge, the traditional analysis capabilities are obviously inadequate; on the other hand, with the rise of new threats represented by APT (Advanced Sustainability Threat) and internal personnel attacks as well as the development of internal control and compliance, there is an increasing need to store and analyse more security information and make decisions and responses more quickly.

Because the large amount of mutually unrelated data streams makes it difficult to form a concise and organized “mosaic” of events, it often takes days or even months to understand the imperceptible security threats. The larger the amount of data collected and analysed and the more chaotic they are, the longer it takes to reconstruct the events.

### SUMMARY OF THE INVENTION

The invention aims to provide a solution for efficiently integrating a large amount of mutually irrelevant security data, automatically identifying abnormal behaviors and forming an abnormal scene which can be understood and explained by enterprise operation and maintenance personnel.

A method for detecting an abnormal behavior of a user of a computer network system according to the present invention, comprising: selecting at least two data sources from the computer network system, the at least two data sources having respective records regarding user behaviors; configuring a tensor data structure corresponding to each data source according to the type of each data source, wherein the tensor data structure defines a plurality of data about user behaviors needing to be extracted from the corresponding data source; extracting the plurality of data about user behaviors from the corresponding data sources respectively by using the configured tensor data structure and performing multidimensional aggregation on the extracted data; and detecting abnormality of a behavior of a user based on the tensor data obtained through aggregation.

The computer network system may include terminal devices, application servers, network devices, and/or other devices that may generate records (logs) regarding user behaviors.

A data source may refer to a log of a corresponding device from which the behavior of a user, application, and/or entity is extracted according to the method of the present invention. Since redundant information such as repeated fields or weak function fields may exist in the log, by extracting valuable information by using a tensor data structure, the redundant information can be removed before the abnormal behavior detection is performed, and only information required for the abnormal behavior detection is reserved. By configuring tensor data structures corresponding to the respective data sources, that is, by defining data (fields) about user behaviors needing to be extracted from the respective data sources, information required for abnormal behavior detection can be flexibly extracted from a plurality of different data sources of the computer network system. Aggregation processing is also required for data extracted from the respective data sources. Here, aggregation means that a plurality of logs having the same feature dimension (dimension) in the same time granularity are accumulated in each scalar dimension (measure), and a scalar attribute (count) can also be automatically added at the same time. The data extraction and aggregation processes simultaneously compress the source data to a great extent, only all the information required for the abnormal analysis is saved, while a large amount of unnecessary repeated or weak functional fields in the source data are avoided, and data redundancy is reduced, so that compression of the original log at two to three orders of magnitude can be realized.

The embodiments of the invention may include one or more of the following features.

The plurality of data extracted from the respective data sources regarding user behaviors contains data regarding a subject of investigation that can be associated with the corresponding users. The subject of investigation may associate a plurality of behavioral features extracted from the respective data sources.

Each user of the computer network system has a unique user identity (ID) for identifying the user. Different data sources may be associated, but it is impossible to obtain such associations in separate logs. By setting the unique user ID, all the behavior logs can be mapped to the corresponding user.

When a plurality of data regarding user behaviors are extracted from a data source not containing the user ID, associate the data regarding the subject of investigation extracted from the data source with the user ID using an association stored in a graph database. By introducing the graph database, various data sources can be linked and complemented, so that data of different data sources can be integrated. Particularly for logs that do not directly include a user ID, a user corresponding to extracted data can be acquired at the time of data extraction using the association in the graph database.

The association is obtained from one or more data dictionaries and/or server dictionaries of the system via a graph data structure, the data dictionaries and/or server dictionaries having recorded therein a correspondence between a subject of investigation of a respective data source and the user ID.

Moreover, an association between at least two of the plurality of data about user behaviors is extracted according to the tensor data structure, and the extracted association is stored in a database. For the case that the user ID is included in the log, an association between the user ID and a certain feature dimension can be created directly by using the tensor data structure. The tensor data structure may also enhance script-defined transformations to further simplify the data in the data source. Furthermore, the tensor data structure also supports slicing in a specified feature dimension, and re-aggregation can be performed in a plurality of specified feature dimensions and scalar dimensions.

The association stored in the graph database is time-stamped. For the convenience of detecting an abnormal behavior of a user, the graph database is a dynamic graph database, that is, the association should always be time stamped no matter if it is from a data dictionary/server dictionary or from log data. If a static data dictionary/server dictionary is involved, the time profile can be obtained by periodic updates. When the database is recorded, the existing association is updated according to the time stamp, and new association is created in different time windows. Thus, when it is necessary to read the association, accurate data of the latest time stamp can be obtained.

The tensor data obtained through aggregation can be stored in a tensor database by taking a data source as a unit. In order to extract the user behavior comprehensively, a tensor database and a graph database are defined and applied at the same time in the invention. For a data source of a given access, the fields and associations required for anomaly detection are defined. The associated data are extracted to enter the graph database; the fields and aggregate values are extracted into the tensor database. The data stored in the tensor database is extracted from the data source by a tensor data structure. Tensor storage is essentially different from conventional vector storage. Tensor storage supports fast slicing or aggregation of individual dimensions or combinations of dimensions, meanwhile supporting multiple scalar dimensions. During the abnormal behavior detection phase, each user of each data source can be extracted as a high-dimensional tensor comprising a time dimension, a plurality of features dimensions and a plurality of scalar dimensions.

The step of performing anomaly detection on the user's behavior based on the tensor data obtained through aggregation includes: configuring a corresponding anomaly detector according to a feature domain and/or a scalar domain to be detected in the tensor data, wherein the anomaly detector is used for detecting one of time-series anomaly, numerical anomaly based on features of the user and anomaly based on the features in the group where the user belongs. The anomaly detector defines the angle of anomaly detection, i.e. the anomaly dimension under investigation (feature dimension and/or scalar dimension). The anomaly detector can select different detection algorithms and normalization functions used by the corresponding algorithms. The detection algorithm may be a specific machine learning algorithm such as a matrix decomposition algorithm, a clustering algorithm, a decision tree algorithm, etc. The matrix decomposition algorithm is a mathematical method under linear algebra, and is used for decomposing an input feature matrix into two matrixes including normal feature numerical values and sparse abnormal numerical values, and finding out the anomaly based on the abnormal numerical values. The clustering algorithm is that each user is abstracted as a plurality of features, and each time granularity has a corresponding set of features. By clustering, the time granularity of most normal behaviors converges together, and those dispersed outside the normal ones are abnormal behaviors. The decision tree algorithm refers to that each user is abstracted as a plurality of features, and each time granularity has a corresponding set of features. A decision tree is generated randomly, wherein the tree formed by the abnormal behaviors has different depths from the tree formed by the normal behaviors.

Anomaly in the association of the users is detected based on the associations stored in the graph database. Associations between the user and other entities are extracted in a time order, wherein the model assumes that the entities which can be associated with the user are kept stable within a certain time, and a new association is singled out as an abnormal relation.

Other aspects, features and advantages of the invention will be further elaborated in the detailed description of the embodiments, the drawings and the claims.

### BRIEF DESCRIPTION OF THE DRAWINGS

The invention is further described with reference to the accompanying drawings.

FIG. 1 schematically illustrates a computer network system;

FIG. 2 is a flow diagram of detecting an abnormal behavior of a user of a computer network system according to one embodiment of the present invention;

FIG. 3 is a schematic diagram of a time series window mechanism, and

FIG. 4 is a schematic diagram of detecting an association of a door access card according to an embodiment of the present invention.

### DETAILED DESCRIPTION

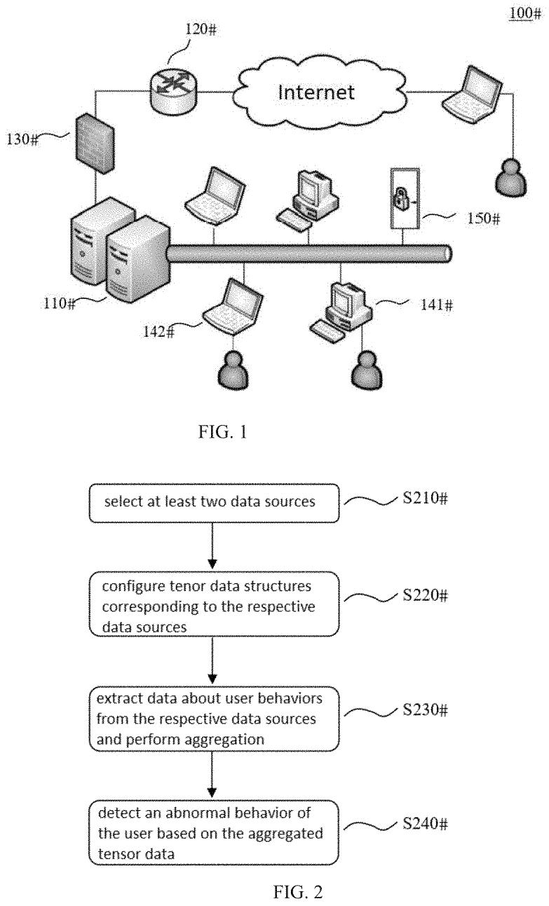

FIG. 1 shows an exemplary computer network system 100, which comprises an application server 110, a router 120 and a firewall 130, terminal devices 141, 142, and a door access system 150. The system 100 is not limited to the illustrated devices and may include other devices capable of generating logs.

A method of detecting an abnormal behavior of a user according to one embodiment of the present invention will be described below with reference to the flowchart of FIG. 2.

According to step S210, two data sources are selected from the computer network system 100: the application server 110 and the door access system 150, so as to extract data regarding user behavior therefrom.

According to step S220, corresponding tensor data structures (tensor schema) are configured for the logs of the application server 110 and the door access system 150 respectively. The tensor data structure defines a plurality of data (fields) about user behaviors that need to be extracted from the respective logs. Specifically, the fields to be extracted from the log of the application server 110 may include c_ip.ip (user IP), cs_uri_stem (website), cs_method (request method), sc_status (status); the fields to be extracted from the logs of the door access system 150 may include card_id (door access card ID), controller_id (manager ID), door_id (access ID), status (status).

Shown below is a pseudo-code example of configuring a tensor data structure for a log of the application server 110:

_type: “IIS log”
query: “*”
entity_field: pc
group_field: [“role”, “department”]
dimension_field: [“c_ip.ip”, “cs_uri_stem”, “cs_method”, “sc_status”]
relationships: [“user>pc”,”user>cs_uri_stem”,”user>cs_method”,
”user> sc_status “]
measure_field: [“count”, “time_taken”]

Shown below is a pseudo-code example of configuring a tensor data structure for a log of the door access system 150:

_type: “door access controller”
query: “*”
entity_field: pc
group_field: [“role”, “department”]
dimension_field: [“card_id”, “controller_id”, “door_id “, “status”]
relationships: [“user>card_id”,”user>controller_id”,”user>door_id”,
”user> status”]
measure_field: [“count”]

According to step S230, a plurality of data on the user behaviors are extracted from the logs of the application server 110 and the door access system 150 respectively through the configured tensor data structure and the extracted data are subjected to multidimensional aggregation, thereby generating corresponding tensor data. The time span of the log involved in this step can be determined by setting the size of the scrolling time window, and generally 4 hours are selected as the minimum granularity, and 1 minute, half an hour, one day or one week, etc. may also be selected as needed.

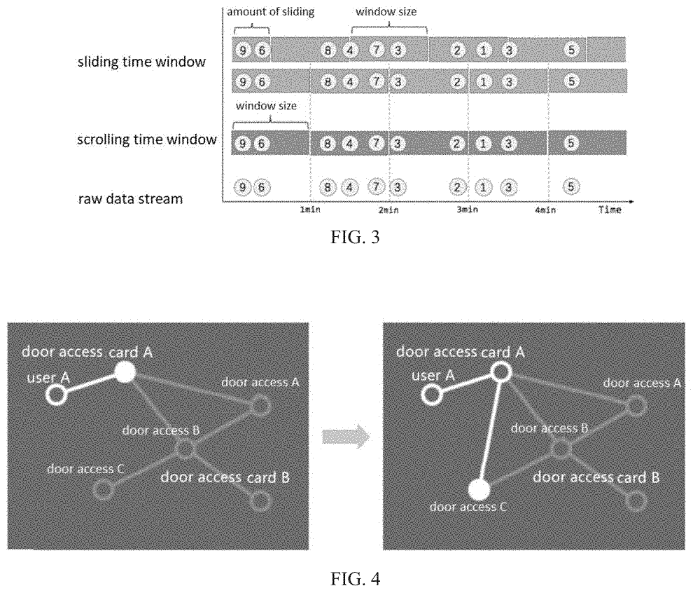

FIG. 3 is a simplified illustration of a rolling time window and a sliding time window in connection with an exemplary raw data stream. Under the mechanism of rolling time window, the data stream is segmented by continuous equal-length time windows; in the sliding time window mechanism, the data stream segmentation is determined by two parameters, window size and sliding amount, and the sliding amount needs to be smaller than the window size, and when the data stream segmentation is performed, the data of adjacent windows are overlapped.

Table 1 shows a sample of tensor data corresponding to a log of the application server 110.

TABLE 1
tensor data samples corresponding to logs of the application server 110

| | c_ip.ip | cs_uri_stem | cs_method | sc_status | time_taken | count |
|---|---|---|---|---|---|---|
| 2016-07- | 111.163.192.68 | /handler/select.a- | POST | “200” | 70 | 1 |
| 10T08:00:00.000Z | | shx | | | | |
| 2016-07- | 117.14.161.205 | /CarveCorpManage | GET | “200” | 172 | 2 |
| 10T08:00:00.000Z | | /CarveCorpSignet | | | | |
| | | Detail.aspx | | | | |
| 2016-07- | 117.14.161.205 | /UploadedFiles/ | GET | “200” | 290 | 6 |
| 10T08:00:00.000Z | | S20160710010048.bmp | | | | |
| 2016-07- | 117.14.161.205 | /carvecorpmanage | POST | “200” | 14188 | 1 |
| 10T08:00:00.000Z | | /MultipleDeliver- | | | | |
| | | Step1.aspx | | | | |

The leftmost column of table 1 shows the start time of the scrolling time window. The length of the scrolling time window is set to be 4 hours by default. The log of the application server 110 in table 1 is, for example, an IIS (Internet Information Services) log includes, for example, 10 HTTP access logs in the scroll time window.

In the tensor data sample shown in table 1, with the user IP serving as the subject of investigation, scalar dimensions time_taken and count are listed to indicate the duration of a corresponding user action (e.g., accessing a certain web site) and the number of times the action occurred, in addition to the defined plurality of feature dimensions (data of user behaviors) cs_uri_stem, cs_method, and sc_status. The time unit in the column of time_taken in table 1 is milliseconds.

The data aggregation takes the subject of inspection and a plurality of feature dimensions as keys, and the accumulation is carried out on two scalar dimensions. For example, as can be seen from the contents of line 4 of Table 1, a user with an IP address of 117.14.161.205 successfully accesses a web site containing the field “/Uploaded Files/S2016071001048.bmp S2016071001048.bmp” six times in succession within 4 hours from 2016-07-10T08: 00: 00.000Z for a total duration of 290 milliseconds.

Table 2 shows a sample of tensor data corresponding to a log of the door access system 150.

TABLE 2
tensor data samples corresponding to logs of the door access system 150

| | card_id | controller_id | door_id | status | count |
|---|---|---|---|---|---|
| 2016-07-10T08:00:00.000Z | 000000000046554B | 0261 | 0012 | success | 1 |
| 2016-07-10T08:00:00.000Z | 00000000006A711D | 0261 | 0012 | success | 2 |
| 2016-07-10T08:00:00.000Z | 0000000000465DF8 | 0262 | 0010 | fail | 16 |
| 2016-07-10T08:00:00.000Z | 0000000000469353 | 0263 | 0001 | success | 1 |

The tensor data in table 2 differs from table 1 in that table 2 takes the door access card ID as the subject of investigation and takes controller_id, door_id and status as the feature dimensions. Further, since the logs of the access control system 150 do not record the time duration for each time of swiping the door access card, table 2 does not include the scalar dimension of time_taken.

The data aggregation takes the investigation subject and a plurality of feature dimensions as keys, and the accumulation is carried out on the scalar dimension of count. For example, as can be seen from the contents of line 4 of table 2, a user holding an door access card with an ID of 0000000000465DF8 failed to swipe a card at a door access point with an ID of 10 managed by a manager with an ID of 0262 for 16 times within 4 hours from 2016-07-10T08: 00: 00.000Z.

Tensor data corresponding to the logs of the application server 110 shown in table 1 and tensor data corresponding to the logs of the door access system 150 shown in table 2 are stored in a tensor database.

Furthermore, since neither the application server 110 log nor the access system 150 log directly includes a user Identity (ID) uniquely identifying the user, it is necessary to access the association stored in the database to obtain the corresponding user ID, thereby associating the data extracted from the log with the corresponding user ID. The association with the user ID is done when the behavioral data is extracted from the data source and stored in the tensor database along with the extracted data. In other words, the information on the user ID is redundantly stored in the tensor data of the respective data sources in the tensor database.

As one approach, the associations stored in the graph database may be obtained from a data dictionary and/or a server dictionary via a graph data structure (graph schema).

Taking a door access log as an example, the fields included therein include a door access card ID, a manager ID, a door access ID etc., but do not directly include a user ID. In usual circumstances, when an enterprise issues a door access card to a user (e.g., an employee of the enterprise), the enterprise records the correspondence between each user ID and the door access card ID. Such a record may be regarded as a data dictionary, and by pre-reading the data dictionary, an association of “door access card ID to user ID” may be created in the graph database. Therefore, when the log of the door access system 150 is extracted, each door access card swiping operation can correspond to the corresponding user ID.

Similarly, an association of “user IP to user ID” may be created in the graph database to associate the information extracted from the IIS log with the corresponding user ID.

Similarly, the fields of Email exchange service logs include senders, receivers etc., and the association can be completed by creating an association from “Email to user ID” by reading the Active Directory server in advance. The following gives a pseudo-code sample of the creation of an associative relationship through a graph data structure:

```
graph:
  csv:
    - _name: “CSV”
      dir: “XXX/LDAP”
      rel: [“email>user”, “user>role”, “user>department”]
  ldap:
    - _name: “LDAP”
          url: “ldap://x.x.x.x:10389/”
          credentials: “********”
      rel: [“mail>uid”, “uid>departmentNumber”]
```

Multiple data sources may be defined simultaneously, such as files like CSV or server dictionaries like LDAP (lightweight directory access protocol). A plurality of associations can be defined in the “rel” array, and are composed of domain A, a domain B, and a connector “>”. All involved fields must appear in the corresponding data source. In addition to the correspondence between the email and the user, the pseudo code may also be used to determine the correspondence between the user and his/her role and department, as will be described further below.

Alternatively, the association stored in the database may also be defined and retrieved from the respective data source by a tensor data structure.

The tensor data structure may specify that two fields in the regular log constitute an association. For example, assuming that the login log of the Active Directory server includes the fields “user ID”, “logged-in PC”, “IP”, and “status”, the association of “user ID to PC name” can be created directly by using the tensor data structure, which is helpful for finding the abnormality of the new association relationship in the detection step after entry of other logs.

For the convenience of detecting an abnormal behavior of the user, the database is a dynamic database, that is, no matter if an association is from a data dictionary/server dictionary or from log data, it is time stamped. If the static data dictionary/server dictionary described above is involved, the time profile can be obtained by periodic updates. When the database is recorded, the existing association is updated according to the time stamp, and new association is created in different time windows. Thus, when the association needs to be read, the correct data of the latest time stamp can be obtained.

A tensor data structure in practical application can define a query of the extracted data and also can define the property features mainly related to the user, such as a PC (personal computer), as a default domain to be investigated in the new association later. For some features or scalars, value transformation or mapping may be required depending on the needs in transaction. The required operations can be defined in a tensor data structure. The following shows a sample of tensor data structure with enhanced functionality configured for HTTP web access logs.

```
_type: “http”
query: “*”
user_field: user
entity_field: pc
group_field: [“role”, “department”]
dimension_field: [“user”, “pc”, “url”, “url>~url_type”]
relationships: [“user>pc”,“~url_type>url”]
measure_field: [“count”]
enrichment:
  script:
    inline: >
      switch (doc.get(‘url’)) {
        case ‘wikileaks.org’ :
          doc.put(‘~url_type’, ‘blacklist leak’);
          break;
        case ‘dropbox.com’ :
    doc.put(‘~url_type’, ‘blacklist cloud_storage’);
    break;
  default:
    doc.put(‘~url_type’, ‘other’);
}
```

In the tensor data structure configured above, the extracted query is *, that is total extraction. The subject of the investigation is a user and the main associated asset is a PC. The investigated feature fields comprise user, pc, url and url_type, and the scalar field is the access amount; the associations extracted in the log include “user >pc”, “˜url_type >url”. In addition, two user grouping methods are defined: users may be grouped by role or by department.

The tensor data structure may enhance script-defined transformations by directly corresponding urls to different blacklist types. For example, wikileks.org is categorized as a leak type blacklist, dropbox.com is categorized as a cloud storage type blacklist, and then a corresponding url type (˜url_type) field is generated. Therefore, in the subsequent analysis process, specific url may not be used, but to simply use the corresponding url type field to realize the blacklist function while simplifying the data. The sorting operation here, as an embedded enhancement script of the tensor data structure, is used to implement ETL (Extract-Transform-Load) processing of data. In addition, there are many other implementations.

Similarly, VPN and firewall logs may be configured with corresponding tensor data structures.

In step S240, anomaly detection of the user behavior is performed based on the aggregated tensor data.

After the data extraction is completed, the anomaly detection of the user behavior can be performed according to the anomaly detector. The anomaly detector constructs the individual components of the detector according to the definition of AD (Anomaly Detection) Schema, wherein the necessary components include: detector names used, data structure (schema) names under investigation for detection, feature dimensions for specified detection, and scalar dimensions for specified detection; optional components include: the algorithm used by the detector, the normalization function used by the algorithm, and the minimum threshold of the anomaly score. Wherein the detector can configure different normalization functions, such as a standard normalization function, to process the tensor into a new tensor with an average value of 0 and a standard deviation of 1. When using some algorithms, different normalization functions can result in different anomalies in the production of the detector. Through the customized components, a plurality of different detectors can be combined so as to be suitable for different anomaly investigation angles and application scenarios.

```
_detector: “XXX_AnomalyDetector”
  schema: [“http”]
  alg:
    name: “XXX_Alg”
    normalizer: “XXX_Normalizer”
  dimension_field: [“~url_type”]
  anomalyScoreThreshold: “0.4”
```

The above is a sample of AD Schema in anomaly detection, where _ detector sets the detector type; schema can pick the previously configured tensor data structure; alg defines the algorithm used by the detector; normalizer defines a normalization function of the features; dimension_field specifies which features are to be extracted; the anomalyScoreThreshold sets the minimum anomaly score threshold, and any anomaly higher than the threshold may be thrown by the detector.

The detector assembly determines the angle at which the anomaly is investigated. For the same set of tensor data stored in the tensor database, it is necessary to use the corresponding detector and the designated fields probably needed when looking at anomalies of different dimensions.

Four anomaly detectors are described in detail below.

### Time Sequence Detector (Time Sequence Anomaly Detection)

The time sequence detector is used for investigating abnormity in a user's behavior from the time sequence, for example, when the user normally goes to work at 9 o'clock, the computer logging on before dawn is abnormal. Specifically, the detector may take a data aggregation time window as a basic granularity, and take the specified sliding time window as a cycle, and the default cycle is 7 days. Please refer to FIG. 3.

The algorithmic model assumes that the user behavior conforms to a certain time series pattern over a longer period of time. The algorithm captures the time-grain at which the behavior deviates from the periodic pattern, with higher deviation values yielding higher anomaly scores.

In the algorithm realization, based on tensor data stored in a tensor database, a user behavior tensor is extracted first, and the behavior tensor is sliced in a single behavior. Then, the data of the single behavior on the time axis is folded in a sliding time window to obtain a two-dimensional matrix. And finally, the obtained matrix is sent into a specifically configured algorithm to obtain an anomaly time grain and an anomaly score thereof. The standard pseudo code is as follows:

```
for each feature f of tensor extracted by ad schema
  sort(f) by timestamp
  fill f with missing timestamp gaps
  normalize(f) by given normalizer
  matrix m = fold f by sliding windows size
  low_rank, sparse, noise = matrix_decomposition(m)
  scores = score_interpreter(sparse)
  for each value in sparse:
    create new anomaly_slice(f, timestamp, value, score)
  return all anomaly_slices
```

### Anomaly Detector Based on User Features

Field data of one or more users under investigation are extracted from a tensor database to form tensor features. Anomaly detection is performed on tensors in a time dimension, and anomaly detection can be performed in cooperation with various types of algorithms, such as matrix decomposition (e.g., RPCA), density or distance-based clustering (e.g., DBSCAN), random forests, self-healing neural networks, and so on. The model assumes that the user has a more stable behavior feature under each feature within a certain time, and the features deviating from the conventional behavior are extracted. The standard pseudo code is as follows:

```
t = tensor extracted by ad schema
flatten(t) by each feature
normalize(t) by given normalizer
list of (feature, timestamp, value, score) = algorithms(t)
scores = score_interpreter(list(score))
for each tuple in list:
  create new anomaly_slice(tuple)
return all anomaly_slices
algorithms(t):
  algs = density based cluster algorithm
        or matrix decomposition algorithm
        or random forest algorithm
        or repeator neural network
  return algs or combination of algs
```

### Anomaly Detector Based on Intra-Group Features

Anomaly analysis takes a user as a subject of investigation, and users who belong to the same department or role may constitute one group, and one user may belong to several different groups. The user ID and the user group are defined at the same time as the tensor data structure is defined so that the detector can use anomaly detection based on the intra-group features. During detection, the user is transversely compared with other users in the same group or the same department, and the users in all the groups are abstracted as a plurality of same features, and each user has a set of features in a single time granularity correspondingly.

The detector based on intra-group features differs from the detector based on user features in the data extraction. The intra-group features are extracted from a plurality of users in the same group or role, and the same fields are extracted for the plurality of users to form a features tensor. The detection algorithm is the same as the method based on the user features.

The model assumes that users of the same group have similar behavior in the same time granularity under the extracted features. Features that deviate from the same set of behaviors are extracted. If a user belongs to both group A and group B, the model assumes that a portion of the features of the user should be consistent with those of group A and another portion of the features should be consistent with those of group B when performing intra-group analysis. The standard pseudo code is as follows:

```
t_all = new tenosr
for user u in group:
  t = tensor extracted by ad schema
  flatten(t) by each feature
  # add t to user dimension with key u
  t_all.add(u, t)
normalize(t_all) by given normalizer
for each timestamp in t_all:
  t_t = t_all slice by timestamp
  list of (feature, user, value, score) = algorithms(t_t)
  scores = score_interpreter(list(score))
  for each tuple in list:
    create new anomaly_slice(timestamp, tuple)
return all anomaly_slices
```

### New Association Detector

The new association detector is based on a graph database. The associations between the user and other entities are extracted in a temporal order. The model assumes that the entity to which the user can be associated remains stable for a certain period of time. New associations (e.g., logging on to a new computer, entering a new access control gate, accessing a new domain name, etc.) will be extracted as anomalies.

For example, user A attempting to log on to another computer adds a new association of the user to the computer and is stored in the “user->computer” relationship graph. When anomaly detection is carried out, all user-computer links of the user A in a set baseline time period are extracted first. Assume that the result of extraction is the set of computers {PC_A, PC_B, PC_C}. Then, extract the link within the current time grain, and assume the result is the set {PC_A, PC_D}. Perform a set subtraction operation, {PC_A, PC_B, PC_C}−{PC_A, PC_D}={PC_D}. The PC_D can be considered as an entity to which the user A is newly associated, that is, a new association relationship appears.

For another example, with reference to FIG. 4, user A has a door access card A and has swiped the card through access control doors A, B. Through the log association, the left graph is constructed at a first time. Using the same method, the right graph was constructed at time 2. As can be seen from the two graphs, the state of the association at a certain time section is stored in the graph database. By means of graph detection, it can be found that the user A is associated with a new access control C through the card A.

The standard pseudo code is as follows:

```
for rel in all relationships:
  connections = search rel.from -(r)- ...... -(r)- rel.to between start_time
  & end_time
  set tos = collect tos from connections
  set new_tos = collect new_tos by current timestamp
  new_entities = new_tos − tos
for each entity in new_entities:
  create new anomaly_slice(entity, timestamp)
return all anomaly_slices
```

By providing multiple different detectors for different data sources, the system may collect multiple single-point anomalies of each user in multiple behavior logs.

The abnormal behavior of each individual detector production can be divided into two types. The first type of alert indicates that a single user has an abnormal behavior for a single time window at a single data type. The second type of alert indicates that an individual user has abnormal behavior at certain feature of a single time window at a single data type. Abnormal behaviors of a single user at single data type will be combined in terms of features and time into a timeline of this abnormal behavior. The set of abnormal points of a single user at the same behavior data type is combined into a set of abnormal behaviors according to features and time, and each abnormal behavior is composed of single abnormal behaviors in the same time sequence. Each abnormal behavior set may contain a start time, an end time, a feature value, an average anomaly score, a total anomaly amount, etc. A plurality of abnormal behavior sets of the same user are matched to form abnormal scenes, and attack chains of user attack behaviors or other abnormal behaviors are obtained by sequencing according to a time axis.

The invention is not limited to the above detailed description. Any variation that readily occur to those skilled in the art based on the above description are within the scope of the invention.

1. A method for detecting an abnormal behavior of a user of a computer network system, comprising:
selecting at least two data sources from the computer network system, the at least two data sources having respective records regarding a user's behavior;
configuring a tensor data structure corresponding to each data source according to the type of each data source, wherein the tensor data structure defines a plurality of data about the user's behavior which need to be extracted from the corresponding data source;
extracting the plurality of data about the user's behavior from the corresponding data sources respectively by using the configured tensor data structure and performing multidimensional aggregation on the extracted data; and
performing anomaly detection on the user's behavior based on the tensor data obtained through aggregation.

2. The method of claim 1, wherein the plurality of data extracted from the respective data sources regarding user behaviors contains data regarding a subject of investigation that can be associated with the corresponding user.

3. The method of claim 2, wherein each user of the system has a unique user identity for identifying the user.

4. The method of claim 3, wherein when a plurality of data regarding user behaviors are extracted from a data source not containing the user identity, data regarding the subject of investigation extracted from the data source are associated with the user identity by using an association stored in a graph database.

5. The method of claim 4, wherein the association is obtained from one or more data dictionaries and/or server dictionaries of the system via a graph data structure, the data dictionaries and/or server dictionaries having recorded therein a correspondence between a subject of investigation of a respective data source and the identity of the user.

6. The method of claim 4, wherein an association between at least two of the plurality of data about the user's behavior is extracted according to the tensor data structure and stored in a graph database.

7. The method of claim 4, wherein the association stored in the graph database is time-stamped.

8. The method of claim 1, wherein the tensor data obtained through aggregation are stored in a tensor database by taking a data source as a unit.

9. The method of claim 1, wherein the step of detecting abnormality of the user's behavior based on the tensor data obtained through aggregation includes: configuring a corresponding anomaly detector according to a feature domain and/or a scalar domain to be detected in the tensor data, wherein the anomaly detector is used for detecting one of time-series anomaly, numerical anomaly based on features of the user and anomaly based on the features in the group where the user belongs.

10. The method of claim 4, wherein an abnormality in the association of the user is detected based on the association stored in the graph database.

11. The method of claim 5, wherein an association between at least two of the plurality of data about the user's behavior is extracted according to the tensor data structure and stored in a graph database.

12. The method of claim 5, wherein the association stored in the graph database is time-stamped.

13. The method of claim 6, wherein the association stored in the graph database is time-stamped.

14. The method of claim 2, wherein the tensor data obtained through aggregation are stored in a tensor database by taking a data source as a unit.

15. The method of claim 3, wherein the tensor data obtained through aggregation are stored in a tensor database by taking data source as a unit.

16. The method of claim 4, wherein the tensor data obtained through aggregation are stored in a tensor database by taking a data source as a unit.

17. The method of claim 2, wherein the step of detecting abnormality of the user's behavior based on the tensor data obtained through aggregation includes: configuring a corresponding anomaly detector according to a feature domain and/or a scalar domain to be detected in the tensor data, wherein the anomaly detector is used for detecting one of time-series anomaly, numerical anomaly based on features of the user and anomaly based on the features in the group where the user belongs.

18. The method of claim 3, wherein the step of detecting abnormality of the user's behavior based on the tensor data obtained through aggregation includes: configuring a corresponding anomaly detector according to a feature domain and/or a scalar domain to be detected in the tensor data, wherein the anomaly detector is used for detecting one of time-series anomaly, numerical anomaly based on features of the user and anomaly based on the features in the group where the user belongs.

19. The method of claim 5, wherein an abnormality in the association of the user is detected based on the association stored in the graph database.

20. The method of claim 5, wherein an abnormality in the association of the user is detected based on the association stored in the graph database.
